(19) United States
(12) Patent Application Publication
(10) Pub. No.: US 2024/0346620 A1
(43) Pub. Date: Oct. 17, 2024

(54) ANALYSIS METHOD AND ANALYSIS APPARATUS

(71) Applicant: National University Corporation Tokai National Higher Education and Research System, Aichi (JP)

(72) Inventors: Shunta HARADA, Nagoya-shi Aichi (JP); Kota TSUJIMORI, Nagoya-shi Aichi (JP); Jun HIROTANI, Nagoya-shi Aichi (JP)

(21) Appl. No.: 18/574,730

(22) PCT Filed: Jun. 28, 2022
(86) PCT No.: PCT/JP2022/025798

§ 371 Date: Dec. 27, 2023

(30) Foreign Application Priority Data
Jun. 30, 2021 (JP) 2021-109205

(51) Int. Cl. G06T 3/4053

(52) U.S. Cl. CPC G06T 3/4053

(57) ABSTRACT

An analysis method includes: acquiring a plurality of actual measurement data items at different measurement points measured by a measuring apparatus capable of measuring a measured quantity at a predetermined resolution; and generating, from the plurality of actual measurement data items, super resolution measurement data having a resolution improved by super resolution. A value of a hyperparameter used in super resolution is determined based on a difference between i) super resolution virtual measurement data generated, from virtual measurement data generated based on a predicted distribution of the measured quantity, by super resolution using the hyperparameter and ii) a distribution of the measured quantity.

### TECHNICAL FIELD

The present disclosure relates to a technology for analyzing measurement data.

### BACKGROUND ART

Spectroscopy has been used in various fields of research, including physics, chemistry, agriculture, and medicine and has yielded many valuable insights. Spectroscopy spectra such as infrared, visible, ultraviolet, X-ray, and electron spectra are often measured using detectors such as charge-coupled devices (CCDs).

### RELATED-ART LITERATURE

### Non-Patent Literature

[NON-PATENT LITERATURE] Murray, C. A. & Dierker, S. B., “Use of an unintensified charge-coupled device detector for low-light-level Raman spectroscopy”, J. Opt. Soc. Am., A3 2151, 1986

### SUMMARY OF INVENTION

### Technical Problem

The resolution of spectroscopy spectrum is limited by the number of detectors. Therefore, it has been difficult to obtain high-resolution spectral data over a wide range.

The present disclosure addresses this issue, and a purpose is to provide a technology for improving the accuracy of measurement data such as spectral data.

### Solution to Problem

An analysis method according to an embodiment of the present disclosure includes: acquiring a plurality of actual measurement data items at different measurement points measured by a measuring apparatus capable of measuring a measured quantity at a predetermined resolution; and generating, from the plurality of actual measurement data items, super resolution measurement data having a resolution improved by super resolution. A value of a hyperparameter used in super resolution is determined based on a difference between i) super resolution virtual measurement data generated, from virtual measurement data generated based on a predicted distribution of the measured quantity, by super resolution using the hyperparameter and ii) a distribution of the measured quantity.

Another embodiment of the present disclosure relates to an analysis apparatus. The apparatus includes: a measurement data acquisition unit that acquires a plurality of actual measurement data items at different measurement points measured by a measuring apparatus capable of measuring a measured quantity at a predetermined resolution; and a super resolution execution unit that generates, from the plurality of actual measurement data items, super resolution measurement data having a resolution improved by super resolution. A value of a hyperparameter used in super resolution is determined based on a difference between i) super resolution virtual measurement data generated, from virtual measurement data generated based on a predicted distribution of the measured quantity, by super resolution using the hyperparameter and ii) a distribution of the measured quantity.

Optional combinations of the aforementioned constituting elements, and implementations of the present disclosure in the form of methods, apparatuses, systems, recording mediums, and computer programs may also be practiced as additional embodiments of the present invention.

### Advantageous Effects of Invention

According to the present disclosure, the accuracy of measurement data is improved.

### BRIEF DESCRIPTION OF DRAWINGS

FIG. 1 is a flowchart showing steps of the analysis method according to the embodiment of the present disclosure.

FIG. 2 is a flowchart showing steps of a preliminary experiment.

FIG. 3 shows an example of the relationship between the value of p and the error.

FIGS. 4A-4C show Raman spectra of the Si substrate measured.

FIG. 5 shows parameters obtained by fitting and values of standard deviation of the background noise.

FIGS. 6A-6E show super resolution Raman spectra.

FIG. 7 shows the peak position and Raman shift estimated from the super resolution Raman spectrum.

FIG. 8 shows one of actual measurement data items for X-ray photoelectron spectroscopy spectrum and super resolution measurement data.

FIG. 9 shows one of actual measurement data items for electron beam energy loss spectroscopy spectrum and super resolution measurement data.

FIG. 10 shows a configuration of the analysis apparatus according to the embodiment of the present disclosure.

### DESCRIPTION OF EMBODIMENTS

In the embodiment of the present disclosure, a technology for improving the resolution and SN ratio of measurement data measured by a measuring apparatus such as a spectrometer will be described.

In order to analyze the peak shift, half-width, etc. of a spectroscopy spectrum, curve fitting is performed using a model function such as Lorentz distribution, Gaussian distribution, and Vogt distribution. Since the distribution of an actual spectroscopy spectrum does not follow the model function perfectly, however, the difference between the actual distribution and the model function creates a systematic error in an analysis result such as peak position.

In the analysis method of this embodiment, the resolution and SN ratio of measurement data are improved by applying a concept of super resolution to measurement data such as spectroscopy spectrum. Thereby, the accuracy of analysis results such as peak position, peak intensity, and half-maximum width is improved.

Bayesian super resolution is a scheme for combining a set of low-resolution images with the same field of view with a sub-pixel relative displacement using Bayes' law to obtain a single image with a higher resolution. In Bayesian super resolution, a sub-pixel displacement and a super resolution image are estimated from a set of low-resolution images for which a prior distribution is postulated.

When Bayesian super resolution is applied to a general image, a natural-looking super resolution image is generated by reconstructing a super resolution image, adjusting, for example, a hyperparameter p that represents the strength of smoothness constraint. Normally, neither the person reconstructing a super resolution image nor the person viewing the reconstructed super resolution image knows the true appearance of an object captured in the image. Therefore, it does not matter much whether the super resolution image accurately reproduces the true appearance. When Bayesian super resolution is applied to measurement data, however, it is required that super resolution measurement data accurately reproduces the true value of the measured quantity.

Since measurement data accompanies some error without exception, it is impossible to know the true value of the measured quantity in principle, and it is difficult to quantitatively evaluate whether the super resolution measurement data accurately reproduces the true value of the measured quantity. In order to improve the reliability of super resolution measurement data, however, it is necessary to have a basis to ensure that the super resolution measurement data reproduces the true value of the measured quantity more accurately than the original measurement data.

In a general image, there is no regularity in the distribution of pixel values. In measurement data, however, there is a regularity in the distribution in many cases, and it is possible to theoretically or empirically predict a distribution that the measurement data will follow at least in general. In the analysis method of this embodiment, a hyperparameter such as p used in super resolution is set to a value capable of accurately reproducing the predicted distribution. Thereby, it is possible to increase the resolution by super resolution of the measurement data using a hyperparameter suitable for the predicted distribution rather than just blindly increasing the resolution. Accordingly, the accuracy and reliability of the super resolution measurement data is improved.

In the analysis method of this embodiment, a preliminary experiment using a predicted distribution is conducted in order to determine such a value of hyperparameter in advance. A plurality of virtual measurement data items derived from adding an error to the true values of the predicted distribution are created. A hyperparameter of super resolution is set. Super resolution virtual measurement data is generated by super resolution from the virtual measurement data. The value of the hyperparameter is determined based on the difference between the true value of the predicted distribution and the super resolution virtual measurement data. Among a plurality of different hyperparameter values, for example, the value that minimizes the difference between the true value of the predicted distribution and the super resolution virtual measurement data is determined as the value of the hyperparameter. Thereby, it is possible to obtain a hyperparameter value capable of accurately reproducing the predicted distribution.

### [Bayesian Super Resolution]

Reconstruction super resolution is directed to generating a closely spaced spectrum x from a set D={yₜ|t=1, 2, . . . , T} of sparsely spaced measured spectra subject to transformation represented by a registration parameter (angle of the grating) θ representing the state of observation. All observed spectra and registration parameters are collectively represented by y=[y₁, . . . , y_{T}], θ=[θ₁, . . . , θ_{T}]. Bayesian super resolution starts with defining two basic probability distributions, i.e., a prior distribution probability p(x) of the closely spaced spectrum, and a conditional probability (likelihood) p(yₜ|x, θₜ) of the observed spectrum yₜ at given x and registration parameter θt. From these two distributions, the closely spaced spectrum is inferred according to Bayes' theorem below, based on the posterior distribution p(x|D, θₜ) given by prior estimation and likelihood.

$$p ( x \vert D \cdot θ ) = \frac{p ( x ) p ( D \vert x \cdot θ )}{p ( D \vert θ )} = \frac{p ( x ) {\prod }_{t = 1}^{T} p ( {y}_{t} \vert x \cdot θ )}{p ( D \vert θ )} . \qquad ( 1 )$$

Bayesian super resolution estimates the registration parameter θ using the marginal likelihood maximization method.

$$\hat{θ} = arg {max}_{θ} L ( θ ) . \qquad ( 2 )$$

where L(θ) is the logarithmic marginal likelihood represented by the following equation.

$$L ( θ ) = ln \int dx p ( x ) p ( D \vert x \cdot θ ) . \qquad ( 3 )$$

After obtaining the estimated registration parameter (θ\hat{ }), the closely spaced spectrum (x\hat{ }) is estimated as the expectation value of the posterior distribution.

$$\hat{x} = E ( x ) = \int dx xp ( x \vert D \cdot \hat{θ} ) . \qquad ( 4 )$$

In this case, prior estimation that represents smoothness constraint given by the following equation is used.

$$p ( x ) = \frac{1}{Z} exp \{ - \frac{ρ}{2} {\sum }_{i \sim j} {( {x}_{i} - {x}_{j} )}^{2} \} = Gauss ( x \vert 0 \cdot {ρ}^{- 1} {A}^{- 1} ) \qquad ( 5 )$$

where ρ is an accuracy parameter that determines the strength of prior belief, i-j represent adjacent values i and j, and a sum is taken over all sets of adjacent values. In this case, the set of values adjacent to the value i on the closely spaced spectrum is represented by N (i). In this case, the exponent of equation (5) is always negative. The equation is a quadratic function of x so that p(x) has a Gaussian distribution. A is a symmetric matrix derived as follows.

$${A}_{ij} = \{ \begin{matrix}\vert N ( i ) \vert & ( i = j ) \\ - 1 & ( i \sim j ) \\ 0 & ( otherwise )\end{matrix} . \qquad ( 6 )$$

The likelihood is defined according to an assumption that the closely spaced spectrum x is geometrically transformed and the observed spectrum yₜ is obtained by an operation disturbed by a Gaussian noise. In the present disclosure, only horizontal translation of spectral data is considered. This operation is represented by the following equation, using the registration parameter θₜ.

$${y}_{t} = W ( {θ}_{t} ) x + {ε}_{t} , {ε}_{t} \sim Gauss ( 0 \cdot {β}^{- 1} I ) . \qquad ( 7 )$$

where W(θₜ) is a non-square matrix representing a geometric transformation, and εₜ is a Gaussian noise of uniform accuracy (inverse variance β). For simplicity, an expression Wt=W(θt) is sometimes used. The likelihood is given by the following equation.

$$p ( {y}_{t} \vert x \cdot {θ}_{t} ) = Gauss ( {y}_{t} \vert W ( {θ}_{t} ) x \cdot {β}^{- 1} I ) . \qquad ( 8 )$$

The Expectation Maximization (EM) algorithm was used to search for the registration parameter. In the expectation value calculation (E) step, the posterior distribution of the closely spaced spectrum x is calculated.

$$p ( x \vert D \cdot θ ) = Gauss ( x \vert μ \cdot \sum ) . \qquad ( 9 )$$

$$where$$

$$\sum = {( ρ A + β {\sum }_{t = 1}^{T} {W}_{t}^{T} {W}_{t} )}^{- 1} \qquad ( 10 )$$

$$μ = β \sum ( {\sum }_{t = 1}^{T} {W}_{t}^{T} {y}_{t} ) . \qquad ( 11 )$$

In the maximization calculation (M) step, the following squared error derived from the likelihood expectation value is optimized by θₜ.

$${\sum }_{t = 1}^{T} E ( {‖ {y}_{t} - W ( {θ}_{t} ) x ‖}^{2} ) = {\sum }_{t = 1}^{T} E \{ {‖ {y}_{t} - W ( {θ}_{t} ) μ ‖}^{2} + tr ( \sum {W ( {θ}_{t} )}^{T} W ( {θ}_{t} ) ) \} \qquad ( 12 )$$

The steps for super resolution of spectroscopic data are as follows.
(Step 1) D, ρ, β, N (number of iterations) are entered.
(Step 2) The initial value θ₀ is set in θ.
(Step 3) Using the input value and θ, μ₀ and Σ₀ are calculated by equation (10) and equation (11).
(Step 4) The following (step 5) and (step 6) are repeated for the index i=1, 2, . . . , N.
(Step 5) Using μᵢ₋₁ and Σᵢ₋₁, θᵢ is optimized by equation (12).
(Step 6) Using the input value and θᵢ, μᵢ and Σᵢ are calculated by equation (10) and equation (11).
(Step 7) μ_{N} and Σ_{N} are output.

The spectroscopic data D is composed of observed values of yₜ (corresponding to the value of “intensity” in Raman spectrum) at respective horizontal positions θₜ_{^{p}} (e.g., corresponding to the value of “wavenumber” in Raman spectrum). The horizontal position θₜ_{^{p}} is determined by the measuring apparatus (in CCD Raman data, for example, the interval between data points is not constant). Further, the displacement θₜ_{^{c}} from the ideal horizontal position exists as a hidden parameter. In this case, therefore, θₜ is composed of θₜ_{^{p}} and θₜ_{^{c}}. In the present disclosure, the squared error shown in equation (12) was optimized by the parameter θₜ_{^{c}} by brute force candidate value search (brute-force search) due to its multimodal nature.

### [Determination of Hyperparameter]

The Bayesian super resolution algorithm of the present disclosure uses two hyperparameters ρ and β. The steps for determining these hyperparameters will be shown. 1/β is set as the value of background noise dispersion of the observed spectroscopic data. The value of ρ was determined from virtual spectroscopic data generated by the following steps. First, the experimental data was fitted to the Lorentz function, and the values of peak height (I₀), peak position (x₀), vertical offset (F₀), and full width at half maximum (FWHM) (w) were estimated. The Lorentz function [(F(x)] is defined by the following equation.

$$F ( x ) = {F}_{0} + {I}_{0} \frac{{w}^{2}}{4 {( x - {x}_{0} )}^{2} + {w}^{2}} . \qquad ( 13 )$$

Next, virtual spectroscopic data was generated from the Lorentz function, using a noise estimate and geometric transformation represented by the registration parameter θₜ. Using the virtual spectroscopic data, the value of ρ was determined so that the error from the Lorentz function is minimized. Using these hyperparameters, it was possible to estimate closely spaced spectrum from the actual data with guaranteed accuracy.

### [Analysis Method According to Embodiment of the Present Disclosure]

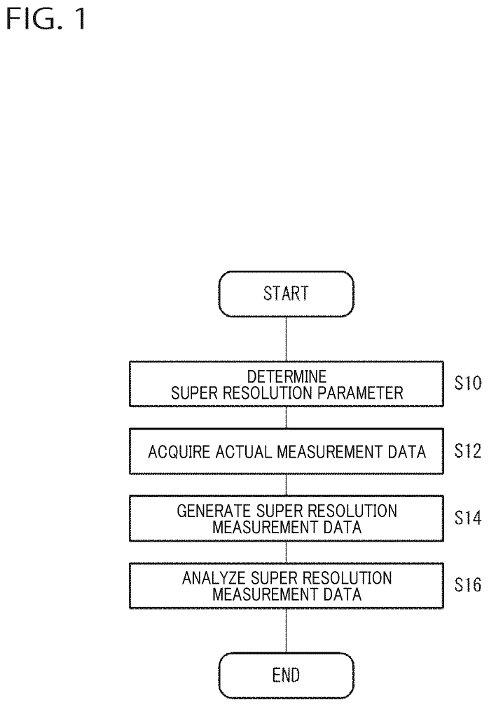

FIG. 1 is a flowchart showing steps of the analysis method according to the embodiment of the present disclosure. This analysis method is executed by an analysis apparatus implemented by a desired computer or the like.

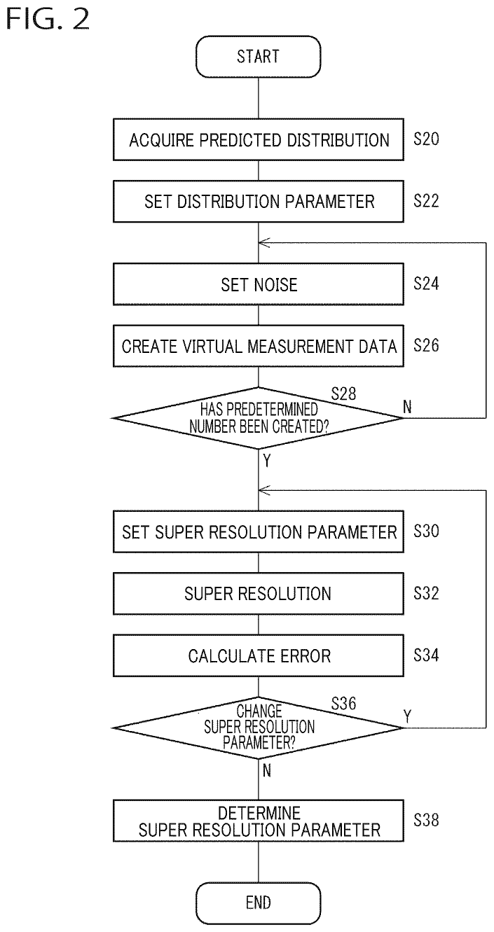

In step S10, the analysis apparatus determines hyperparameters of super resolution through a preliminary experiment. FIG. 2 is a flowchart showing steps of a preliminary experiment.

In the preliminary experiment, the analysis apparatus first acquires a predicted distribution of the measured quantity measured by the measuring apparatus (S20). The measured quantity may be a spectroscopy spectrum determined by spectroscopy such as Raman spectroscopy, electron energy loss spectroscopy (EELS), energy dispersive X-ray spectroscopy (EDX), Auger electron spectroscopy (AES), X-ray photoelectron spectroscopy (XPS), X-ray fluorescence spectroscopy (XRF), X-ray diffraction (XRD), luminescence/absorption spectroscopy, photoluminescence spectroscopy (PL), cathodoluminescence spectroscopy (CL), inductively coupled plasma optical emission spectroscopy (ICP-AES), inductive plasma mass spectrometry (ICP-MS), or a quantity of a desired type that can be measured by a scheme such as desired physical, chemical, and electrical. Alternatively, the measured quantity may be a quantity such as a histogram representing frequency or probability. The predicted distribution may be, for example, a probability distribution. A probability distribution is a function that gives a probability that a random variable will have a certain value or belong to a certain set. The predicted distribution may be a distribution represented by a Lorentz function, Gaussian function, Vogt function, pseudo-Vogt function, Chesler-Cram peak function, Edgeworth-Cramer peak function, exponentially modified Gaussian function, Gram-Charlier peak function, Giddings peak function, Logistic peak function, Probit function, Pearson peak function, Weibull peak function, Poisson distribution function, pulse function, Laplace function, general exponential function, Beta function, sigmoid function, asymmetric double sigmoid function, Extreme function, power polynomial function, trigonometric function, exponential function, double exponential function, attenuation exponential function, hyperbolic function, Hill function, or a function obtained by an arithmetic operation on these functions, or a composite of selected functions. The predicted distribution may be a distribution obtained by linear interpolation, Lagrangian interpolation, spline interpolation, interpolation using Newtonian radial basis function interpolation, interpolation using fuzzy inference, Fourier transform, or Laplace transform.

The analysis apparatus sets the value of the parameter of the predicted distribution (S22). In the case of Lorentz distribution, for example, the value of a parameter such as ω included in the Lorentz function is set. The value of the parameter may be set according to the type of measured quantity to be analyzed, performance of the measuring apparatus, and the like. The value of the parameter of distribution obtained by curve fitting the measurement data measured by the measuring apparatus may be set.

The analysis apparatus determines the magnitude of measurement noise and the magnitude of noise representing a displacement of the measurement point (S24). These noises may be determined by using a Gaussian function, assuming that the noises follow a normal distribution.

The analysis apparatus shifts each measurement point by adding a noise, which represents the magnitude of displacement of the measurement point, to each measurement point, calculates the true value of the distribution at the shifted measurement point, and adds the measurement noise to the calculated true value, thereby creating virtual measurement data (S26).

The analysis apparatus creates a predetermined number of virtual measurement data items (Y in S28), changing the value of noise by repeating S24 and S26, until a predetermined number of virtual measurement data items are created (N in S28).

The analysis apparatus sets the value of a hyperparameter of super resolution (S30) and generates super resolution virtual measurement data from the plurality of virtual measurement data items thus created (S32). The hyperparameter of super resolution may be, for example, the strength of smoothness constraint ρ, the reciprocal β of an estimate of noise dispersion, and the like.

The analysis apparatus estimates the peak position of the super resolution virtual measurement data by curve fitting the super resolution virtual measurement data with a function representing the predicted distribution and moves the super resolution virtual measurement data so that the peak position matches the predicted distribution. The analysis apparatus calculates errors (absolute value of the difference) between the true value of the predicted distribution and the super resolution measurement data at respective measurement points and calculates an average of the errors (S34).

The analysis apparatus repeats S30-S34, changing the value of the hyperparameter of super resolution (Y in S36). Once the errors are calculated by changing the value of the hyperparameter of super resolution over a predetermined range (N in S36), the hyperparameter that gives the smallest error among the values is determined (S38).

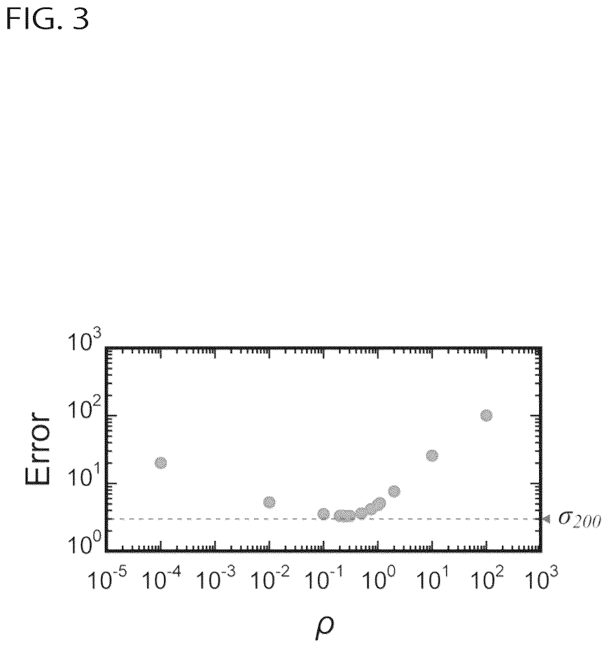

FIG. 3 shows an example of the relationship between the value of ρ and the error. As will be described in detail in the examples described below, a preliminary experiment was conducted to determine ρ using a Lorentz distribution. ρ is a hyperparameter representing the strength of smoothness constraint, and the larger ρ, the greater the degree to which the measurement data is smoothed. If ρ is too small, the measurement noise cannot be reduced, and the accuracy is not improved because the position is adjusted with the measurement noise being superimposed. If ρ is too large, the measurement noise is reduced, but the accuracy is not improved because the data is smoothed too much and the peak is crushed. When ρ is set to an appropriate value, it is possible to reduce the measurement noise and, at the same time, prevent the peak from being crushed. Accordingly, the accuracy of the super resolution virtual measurement data is improved.

Referring back to FIG. 1, the analysis apparatus acquires, in step S12, a plurality of actual measurement data items at different measurement points measured by a measuring apparatus capable of measuring the measured quantity at a predetermined resolution. The measured quantity is generally a continuous quantity and is measured discretely at a resolution determined by the number of detectors of the measuring apparatus, etc. The analysis apparatus acquires a plurality of actual measurement data items measured multiple times while shifting the measurement point at intervals smaller than the interval between measurement points of the measuring apparatus. If the interval between measurement points of the measuring apparatus is not constant, the analysis apparatus may acquire a plurality of actual measurement data items measured multiple times while shifting the measurement point at intervals at least smaller than the widest interval.

In step S14, the analysis apparatus sets the hyperparameter of super resolution and generates the super resolution measurement data from the plurality of actual measurement data items by super resolution using the hyperparameter thus set. The analysis apparatus sets the value determined in the preliminary experiment in ρ. The analysis apparatus may set the reciprocal of the value of background noise dispersion measured by the measuring apparatus in β.

In step S16, the analysis apparatus analyzes the super resolution measurement data generated. The analysis apparatus may analyze, for example, peak position, peak intensity, half-maximum full width, vertical offset, and the like.

The “actual measurement data” may be a collection of sparse discrete vector data for which the number of measurement points is the same and which accompanies an indeterminate initial shift. “Super resolution” is a Bayesian estimation model based on a Markov probability field and may use the expectation value maximization method to predict the initial shift of the actual measurement data. “Hyperparameter” may be a super resolution hyperparameter for determining a prior probability distribution relating to a normally distributed model based on a derivative matrix of a super resolution Markov probability field. “Virtual measurement data” may be obtained by determining, based on the actual measurement data, the mathematical specification of a continuous function model assigned based on a belief, and by adding uncertainty to the horizontal axis and adding noise based on a noise statistical model to the vertical axis.

### [Example 1] Raman Spectrum

The Raman spectrum of a Si substrate (NMIJ CRM 5606-a) for positron defect measurement obtained from National Metrology Institute of Japan of National Institute of Advanced Industrial Science and Technology was measured. The standard data for Raman shift of this Si substrate is reported to be 520.45±0.28 cm⁻¹ by National Metrology Institute of Japan of National Institute of Advanced Industrial Science and Technology.

An inVia Raman microscope from Renishaw was used to measure the Raman spectrum of the Si substrate at room temperature. The wavelength of the incident laser was 532 nm, and the width of the grating was 3000 gr/mm. The resolution of the spectrum obtained was about 0.8 cm⁻¹ near 520 cm⁻¹. An objective lens having a magnification factor of 5 was used, and the acquisition time was 1 second. 200 Raman spectra were obtained, changing the horizontal offset value by about 0.01 cm⁻¹ in each step.

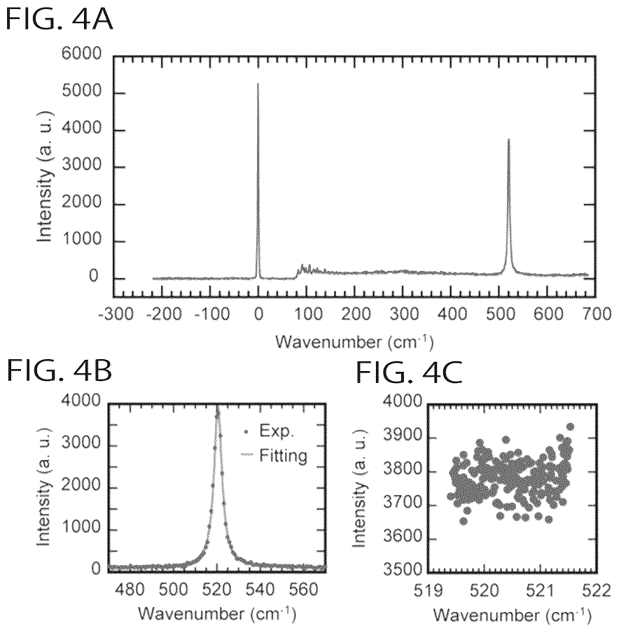

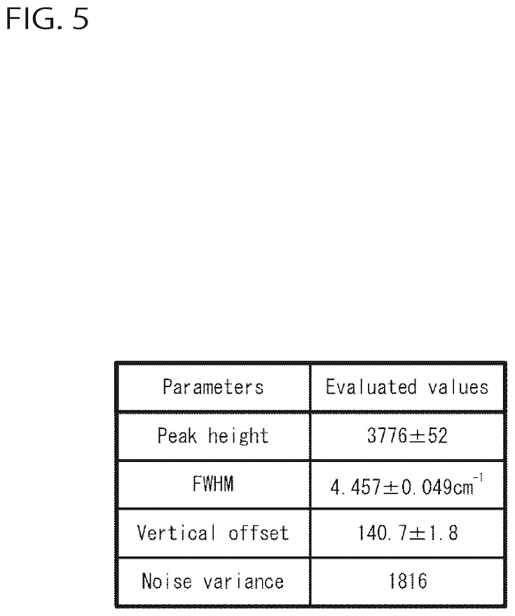

FIG. 4A shows one of the Raman spectra of the Si substrate measured. Due to the influence of the edge filter, the background changes sharply near 100 cm⁻¹. In addition to the Raman shift of Si near 520 cm⁻¹, leakage of Rayleigh scattering was observed near 0 cm⁻¹. As shown in FIG. 4B, it was confirmed that the peak intensity and peak position were randomly distributed as shown in FIG. 4C when all Raman shifts were fitted and evaluated with the Lorentz function. FIG. 5 shows parameters obtained by fitting and values of standard deviation of the background noise.

Subsequently, a preliminary experiment was conducted to determine the hyperparameter p of super resolution. We created 200 virtual measurement data items and evaluated the error between the true value calculated from the Lorentz function and the super resolution spectrum, changing the value of ρ. The relationship between the value of ρ and the error is as shown in FIG. 3. The value of ρ that gives the smallest error was 2.6×10⁻¹. The average error of super resolution in this case is as low as 3.31, which is almost identical to the standard deviation (σ₂₀₀=3.01) estimated in the 200 virtual measurement data items. Both resolution improvement by Bayesian super resolution and noise reduction by data accumulation are found to be achieved.

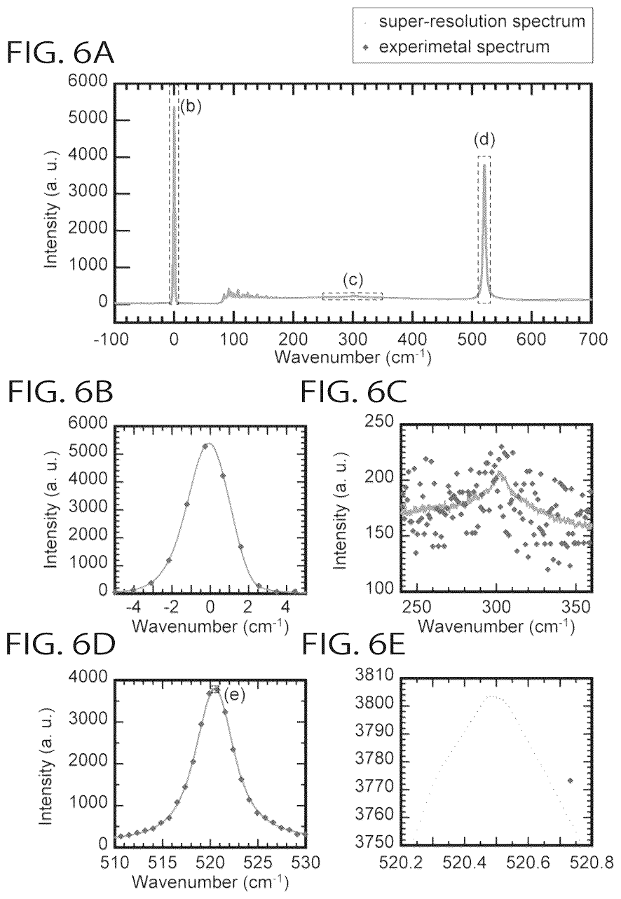

The super resolution Raman spectrum was reconstructed with a wavenumber resolution of 0.01 cm⁻¹ by Bayesian super resolution using the hyperparameter determined through the preliminary experiment. FIG. 6 shows the super resolution Raman spectrum generated. Although the super resolution Raman spectrum displayed over an extensive range (FIG. 6A) appears to be almost identical to the actually measured Raman spectrum shown in FIG. 4A, the magnified super resolution Raman spectrum clearly shows the result of super resolution. The peak shape of the Rayleigh scattering leak near 0 cm⁻¹ shown in FIG. 6B was not an ideal Gaussian type but was asymmetric. This is considered to be due to the actual state of the edge filter. Near 300 cm⁻¹, a very weak peak originating from two-photon Raman scattering was observed, as shown in FIG. 6C. Compared to the actually measured Raman spectrum, not only high resolution but also noise reduction is achieved. Near 520 cm⁻¹, one-photon Raman scattering, which is not an ideal shape of the Lorentz function, was observed as shown in FIG. 6D. Magnifying the spectrum further, it is found that the shape of the peak top is asymmetrical. This is considered to be due to an optical misalignment so slight that it is not noticeable in normal measurement.

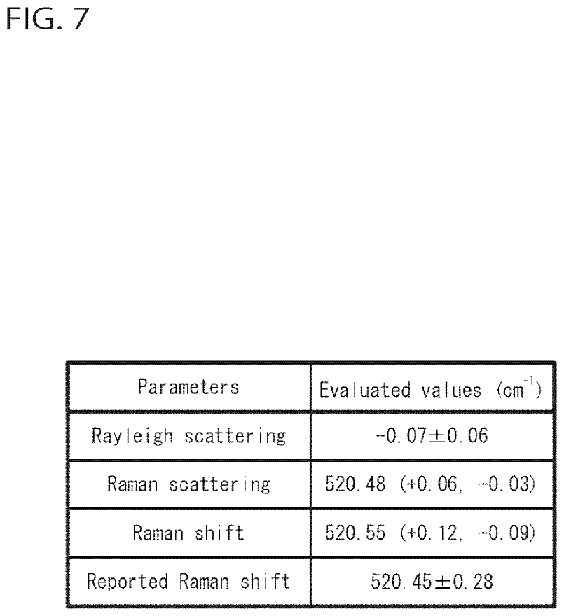

FIG. 7 shows the peak position and Raman shift estimated from the super resolution Raman spectrum. The estimated Raman shift was consistent with the value reported by National Metrology Institute of Japan of National Institute of Advanced Industrial Science and Technology. From the Raman spectrum measured by a measuring apparatus having a wavenumber resolution of about 0.8 cm⁻¹, it was demonstrated that a highly reliable super resolution Raman spectrum having a wavelength resolution of 0.01 cm⁻¹ is obtained.

### [Example 2] X-Ray Photoelectron Spectroscopy (XPS) Spectrum

The X-ray photoelectron spectroscopy spectrum of a sample was measured multiple times, and the actual measurement data was used to generate super resolution measurement data.

Using a 4H—SiC epitaxial substrate as a sample, the X-ray photoelectron spectroscopy spectrum was measured using ESCA-3300 from Shimadzu. The interval between measurement data points is ΔE=0.1 eV, the measurement range is 110-95 eV (Si2p binding energy), and the number of measurement data items is 100. The magnification factor of super resolution is 10, and the interval between super resolution measurement data points is ΔE=0.01 eV.

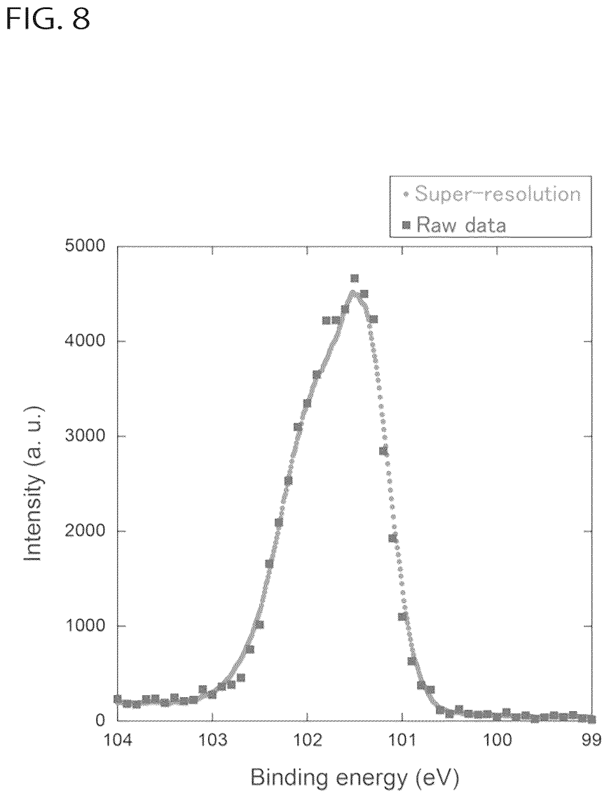

FIG. 8 shows one of actual measurement data items for X-ray photoelectron spectroscopy spectrum and super resolution measurement data. A complex peak shape formed by peaks corresponding to Si2p_{1/2}, Si2p_{3/2}, and Si—C bonds overlapping each other near 101.5 eV is reconstructed in the super resolution measurement data. The super resolution measurement data is also in good agreement with the actual measurement data obtained by separately measuring the same sample at intervals of ΔE=0.01 eV. Thus, it has been demonstrated that the technology of this embodiment is equally applicable to super resolution of XPS spectrum.

In X-ray photoelectron spectroscopy, the energy of photoelectrons ejected from a sample is measured by irradiating the sample with X-rays. When the sample is an insulator in this case, a positive charge is accumulated at the measurement site so that an energy shift of photoelectrons occurs due to the accumulated positive charge. Therefore, accurate measurement is very difficult in principle. By applying the technology of this embodiment, however, a precise XPS spectrum in which the energy shift is corrected is obtained. In the analysis method of this embodiment, it is necessary to measure multiple times while shifting the measurement point to determine actual measurement data. When the method is applied to the X-ray photoelectron spectroscopy spectrum of an insulator, however, an energy shift of photoelectrons occurs in principle. Therefore, the X-ray photoelectron spectroscopy spectrum may be measured multiple times without shifting the measurement point.

### [Example 3] Electron Beam Energy Loss Spectroscopy (EELS) Spectrum

The electron beam energy loss spectroscopy spectrum of a sample was measured multiple times, and the actual measurement data was used to generate super resolution measurement data.

Using Rutile (TiO₂) as a sample, the electron beam energy loss spectroscopy spectrum was measured using ARM-200F from JEOL. The interval between measurement data points is ΔE=0.25 eV, the measurement range is −10-500 eV, and the number of measurement data items is 100. The magnification factor of super resolution is 10, and the interval between super resolution measurement data points is ΔE=0.025 eV.

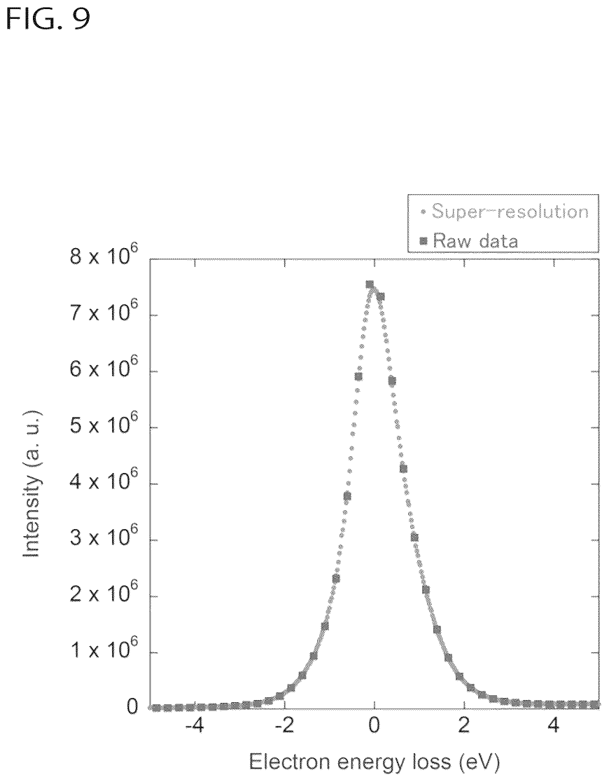

FIG. 9 shows one of actual measurement data items for electron beam energy loss spectroscopy spectrum and super resolution measurement data. A zero-loss peak is reconstructed in the super resolution measurement data. Even if the actual measurement data has an asymmetric peak shape, therefore, the position of the zero-loss peak can be accurately determined without curve fitting. Thus, it has been demonstrated that the technology of this embodiment is equally applicable to super resolution of EELS spectrum.

In electron beam energy loss spectroscopy, an electron beam is caused to be incident on a sample, and the energy lost when the incident electron beam excites electrons in the sample is measured. In this process, an energy shift of the incident electron beam occurs due to the influence of the electric field in the measurement environment. Therefore, accurate measurement is very difficult in principle. By applying the technology of this embodiment, however, a precise EELS spectrum in which the energy shift is corrected is obtained. In the analysis method of this embodiment, it is necessary to measure multiple times while shifting the measurement point to determine actual measurement data. When the method is applied to X-ray photoelectron spectroscopy spectrum of an insulator, however, an energy shift of photoelectron occurs in principle. Therefore, the X-ray photoelectron spectroscopy spectrum may be measured multiple times without shifting the measurement point.

The technology of this embodiment is applicable to measurement of spectroscopy spectrum for evaluating stress, impurity concentration, physical properties, etc. of various materials such as semiconductors and electronics materials, to temperature measurement of organic solutions, etc.

### [Analysis Apparatus According to the Embodiment of the Present Disclosure]

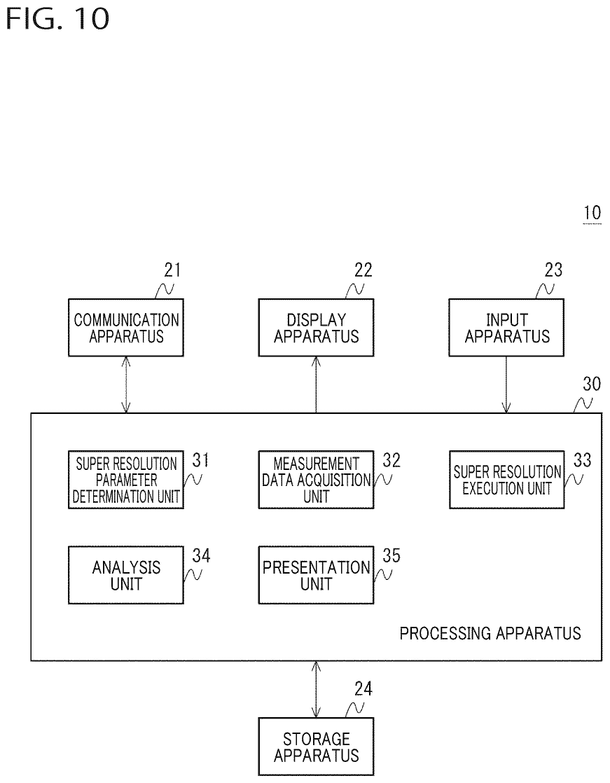

FIG. 10 shows a configuration of the analysis apparatus 10 according to the embodiment of the present disclosure. The analysis apparatus 10 includes a communication apparatus 21, a display apparatus 22, an input apparatus 23, a storage apparatus 24, and a processing apparatus 30. The analysis apparatus 10 may be a server apparatus, an apparatus such as a personal computer, or a mobile terminal such as a mobile phone terminal, a smartphone, and a tablet terminal.

The communication apparatus 21 controls communication with other apparatuses. The communication apparatus 21 may communicate by a desired wired or wireless communication scheme. The display apparatus 22 displays a screen generated by the processing apparatus 30. The display apparatus 22 may be a liquid crystal display apparatus, an organic EL display apparatus, or the like. The input apparatus 23 transmits an instruction input by the user or manager of the analysis apparatus 10 to the processing apparatus 30. The input apparatus 23 may be a mouse, keyboard, touchpad, or the like. The display apparatus 22 and the input apparatus 23 may be implemented as a touch panel. The storage apparatus 24 stores a program, data, and the like used by the processing apparatus 30. The storage apparatus 24 may be a semiconductor memory, a hard disk, or the like.

The processing apparatus 30 includes a super resolution parameter determination unit 31, a measurement data acquisition unit 32, a super resolution execution unit 33, an analysis unit 34, and a presentation unit 35. The features are implemented in hardware such as a desired circuit and a CPU, a memory, or other LSIs, of a computer and in software such as a program loaded into a memory. The figure depicts functional blocks implemented by the cooperation of these elements. Therefore, it will be understood by those skilled in the art that these functional blocks may be implemented in a variety of manners by hardware only or by a combination of hardware and software.

The super resolution parameter determination unit 31 determines the hyperparameter of super resolution through a preliminary experiment. The super resolution parameter determination unit 31 determines the value of the hyperparameter based on the difference between i) each of a plurality of super resolution virtual measurement data items generated, from the virtual measurement data generated based on a predicted distribution of the measured quantity, by super resolution using the hyperparameter of a plurality of different values and ii) the true of the distribution.

The measurement data acquisition unit 32 acquires a plurality of actual measurement data items at different measurement points determined by a measuring apparatus capable of measuring the measured quantity at a predetermined resolution.

The super resolution execution unit 33 sets the hyperparameter of super resolution determined by the super resolution parameter determination unit 31 and generates super resolution measurement data from the plurality of actual measurement data items by super resolution using the hyperparameter thus set.

The analysis unit 34 analyzes the super resolution measurement data thus generated to estimate peak position, peak intensity, peak shift amount, and the like.

The presentation unit 35 displays the super resolution measurement data generated by the super resolution execution unit 33, the result of analysis by the analysis unit 34, and the like on the display apparatus 22.

Described above is an explanation based on an exemplary embodiment. The embodiment is intended to be illustrative only and it will be understood by those skilled in the art that various modifications to constituting elements and processes could be developed and that such modifications are also within the scope of the present disclosure.

### INDUSTRIAL APPLICABILITY

The present disclosure can be used in an analysis apparatus that analyzes measurement data.

### REFERENCE SIGNS LIST

10 analysis apparatus, 31 super resolution parameter determination unit, 32 measurement data acquisition unit, 33 super resolution execution unit, 34 analysis unit, 35 presentation unit

1. An analysis method comprising:
acquiring a plurality of actual measurement data items measured by a measuring apparatus capable of measuring a measured quantity at a predetermined resolution, measurement points of the actual measurement data items being shifted by different amounts of shift; and
determining, through a preliminary experiment, a value of a hyperparameter set in super resolution for generating, from the plurality of actual measurement data items, super resolution measurement data having a resolution improved from the predetermined resolution; and
generating, from the plurality of actual measurement data items, the super resolution measurement data by super resolution in which the value of the hyperparameter determined is set,
wherein the preliminary experiment includes:
generating a plurality of virtual measurement data items based on a predicted distribution of the measured quantity, measurement points of the virtual measurement data items being shifted by different amounts of shift;
generating, from the plurality of virtual measurement data items, super resolution virtual measurement data by super resolution; and
determining the value of the hyperparameter based on a difference between the super resolution virtual measurement data generated and the distribution.

2. The analysis method according to claim 1,
wherein generating the virtual measurement data includes generating the plurality of virtual measurement data items, with the measurement points being shifted by different amounts of shift, by adding, to the predicted distribution of the measured quantity, a shift in the measurement point and a measurement noise.

3. The analysis method according to claim 1,
wherein generating the super resolution virtual measurement data includes generating the super resolution virtual measurement data by super resolution from the plurality of virtual measurement items while changing the value of the hyperparameter.

4. The analysis method according to claim 1,
the preliminary experiment includes predicting the distribution by using the actual measurement data.

5. The analysis method according to claim 1,
determining the value of the hyperparameter includes determining a value that minimizes a difference between the super resolution virtual measurement data and the distribution as the value of the hyperparameter.

6. The analysis method according to claim 1,
wherein the distribution is a probability distribution.

7. The analysis method according to claim 1,
wherein the hyperparameter is a parameter that represents a strength of smoothness constraint.

8. An analysis apparatus comprising:
a measurement data acquisition unit that acquires a plurality of actual measurement data items measured by a measuring apparatus capable of measuring a measured quantity at a predetermined resolution, measurement points of the actual measurement data items being shifted by different amounts of shift; and
a super resolution execution unit that generates, from the plurality of actual measurement data items, super resolution measurement data having a resolution improved from the predetermined resolution by super resolution,
wherein a value of a hyperparameter used in super resolution is determined by a preliminary experiment, and
wherein the preliminary experiment includes:
generating a plurality of virtual measurement data items based on a predicted distribution of the measured quantity, measurement points of the virtual measurement data items being shifted by different amounts of shift;
generating, from the plurality of virtual measurement data items, super resolution virtual measurement data by super resolution; and
determining the value of the hyperparameter based on a difference between the super resolution virtual measurement data generated and the distribution.

9-10. (canceled)
